(19) United States
(12) Patent Application Publication
(10) Pub. No.: US 2025/0333588 A1
(43) Pub. Date: Oct. 30, 2025

(54) HALOGEN-FREE FLAME RETARDANT POLYMER COMPOSITION

(71) Applicant: Borealis AG, Vienna (AT)

(72) Inventors: Roberta Pellecchia, Linz (AT); Susanne Nilsson, Stenungsund (SE); Antonis Gitsas, Linz (AT)

(21) Appl. No.: 18/700,329

(22) PCT Filed: Oct. 12, 2022
(86) PCT No.: PCT/EP2022/078361

§ 371 Date: Apr. 11, 2024

(30) Foreign Application Priority Data
Oct. 15, 2021 (EP) 21202969.8

(51) Int. Cl. C08L 23/0853; C08K 3/22; C08K 3/32; H01B 3/44; H01B 7/295

(52) U.S. Cl. CPC C08L 23/0853; C08K 3/22; C08K 3/32; H01B 3/441; H01B 7/295; C08K 2003/2227; C08K 2003/328; C08K 2201/014; C08L 2201/02; C08L 2203/202; C08L 2205/025; C08L 2205/03; C08L 2207/064; C08L 2207/066

(57) ABSTRACT

The present invention relates to a halogen-free flame retardant polymer composition, particularly a flame retardant polymer composition comprising zirconium phosphate and further relates to a wire or cable comprising at least one layer comprising the above flame retardant polymer composition and to the use of zirconium phosphate for improving the flame retardant and/or water absorption properties of a polymer composition. The flame retardant polymer composition comprises at least (A) 2.0 to 49.8 wt.-%. based on the overall weight of the polymer composition of an ethylene copolymer containing monomer units with polar groups: (C) 30 to 65 wt.-%, based on the overall weight of the polymer composition of a flame retardant filler: (D) 2.0 to 10.0 wt.-%, based on the overall weight of the polymer composition of zirconium phosphate. and optionally (B) up to 6.0 wt.-%, based on the overall weight of the polymer composition of an ethylene homo-or copolymer and/or a propylene homo-or copolymer containing units originating from maleic acid anhydride and/or further optionally (E) up to 17.0 wt.-% based on the overall weight of the polymer composition of a copolymer of ethylene and a C₄ to C₁₀ alpha olefin comonomer having a density in the range of 860 kg/m³ to 965 kg/m³, determined according to ISO 1183.

### CROSS REFERENCE TO RELATED APPLICATIONS

This is a 371 of PCT Application No. PCT/EP2022/078361, filed Oct. 12, 2022, which claims the benefit of European Application No. 21202969.8, filed Oct. 15, 2021, the contents of which are incorporated herein in their entirety.

### DETAILED DESCRIPTION

The present invention relates to a halogen-free flame retardant polymer composition, particularly a flame retardant polymer composition comprising zirconium phosphate. The present invention further relates to a wire or cable comprising at least one layer comprising the above flame retardant polymer composition and to the use of zirconium phosphate for improving the flame retardant properties of a polymer composition.

A wide variety of polymeric materials have been utilized as electrical insulating and semiconducting shield materials for power cables. Such polymeric materials in addition to having suitable dielectric properties must also be enduring and must substantially retain their initial properties for effective and safe performance over many years of service. Such materials have also to meet stringent safety requirements as laid down in international standards. In particular, single cable, or bundle of cables, must not burn by itself or transmit fire; the combustion gases of a cable must be as harmless as possible to humans, the smoke and combustion gases formed must not obscure escape routes or be corrosive.

The flame retardant demands for cables used in buildings have increased following e.g. the introduction of the “construction product directive” (CPR) within the European Union. The CPR set specific standards for smoke generation, the dripping-off of particles and the acidity of smoke in construction materials such as cables. In EN50575 the European classes for cables are defined and every country has now decided which cable class should be used for a specific building. For cables, the classes E, D, C and B2 are of interest.

European thermoplastic and crosslinked cable insulation according to EN50525, e.g. H07Z1 and H07Z cables are required to fulfil specific flame retardant, mechanical and dry electrical properties.

In the USA, flame retardant insulation cables, thermoplastic and crosslinked cables must meet UL requirements with focus on flame retardant, mechanical and wet electrical properties, as described e.g. in UL2556.

Flame retardants are chemicals used in polymers that inhibit or resist the spread of fire. For improving the flame retardancy of polymer compositions to be used in wires or cables, compounds containing halides were first added to the polymer. However, these compounds have the disadvantage that upon burning, hazardous and corrosive gases like hydrogen halides are liberated.

Then, one approach to achieve high flame retardant properties in halogen-free polymer compositions has been to add large amounts, typically 50 to 60 wt.-% of inorganic fillers such as hydrated and hydroxy compounds. Such fillers, which include Al(OH)₃ and Mg(OH)₂ decomposes endothermically at temperatures between 200 and 600° C., liberating inert gases. The drawback of using large amounts of fillers is the deterioration of the processability and the mechanical properties of the polymer composition.

WO 2014/121804 A1 refers to halogen free, thermoplastic or cross-linked polymer compositions comprising a polyolefin and/or a polyolefin containing polar co-monomers and a combination of metal hydroxides and inorganic hypophosphite as a synergistic additive, and optionally other ingredients. Molded items obtained using the polymer composition are useful in a wide range of injection molding and extrusion applications, especially cables.

US 2013/0220667 A1 discloses a polyolefin-based composition for manufacturing halogen-free, flame retardant, low smoke emission, thermoplastic insulations showing good electrical properties in water for use in electrical conductor cables. The composition comprises in parts per hundred of resin (phr): a) a mixture of at least two polyolefin-based polymer resins, comprising from about 5 to about 95 phr of a first soft and flexible resin and from about 5 to about 95 phr of a second tensile strength and heat-resistance provider resin; b) from about 0.2 to about 50 phr of at least one compatibilizing and/or coupling agent; c) from about 40 to about 270 phr of at least one flame retardant, d) from about 0.1 to about 15 phr of at least one antioxidant; and e) from about 0.2 to about 5 phr of at least one lubricant. The soft and flexible resin of the mixture of at least two polymer resins is selected from polyethylene vinyl acetate (EVA), polyethylene butyl acrylate (EBA), polyethylene ethyl acrylate (EEA), polyethylene methyl acrylate (EMA), linear low density polyethylene (LLDPE) and ethylene propylene copolymers (EP) and the tensile strength and heat-resistance provider resin of the mixture of at least two polymer resins is selected from high density polyethylene (HDPE), polypropylene (PP) and ethylene-propylene copolymers (EP).

CN 104004258 A discloses a low-smoke halogen-free flame-retardant ethylene-vinyl acetate copolymer resin, made of ethylene-vinyl acetate rubber, a halogen-free flame-retardant system and a processing aid. The halogen-free composite flame-retardant system is made of an inorganic aluminum hydroxide or inorganic magnesium hydroxide; the processing aid consists of talc, titanium dioxide, carbon black, or a crosslinking agent.

JP H05-74231 A discloses a flame retardant polymer composition for an insulated electric wire that does not generate harmful gas at the time of ignition and has a heat-resistant aging property that satisfies the UL 44 standard. The polymer composition comprises an organosilicon compound surface-treated with a polyolefin resin, e.g. polyethylene, ethylene-a-olefin copolymer, ethylene-propylene-based thermoplastic elastomer, ethylene-vinyl acetate copolymer, ethylene-ethyl acrylate copolymer, and ethylene-methyl methacrylate, or mixtures thereof. The composition further comprises a magnesium hydroxide filler.

In general, the addition of flame retardant fillers in polymer compositions for wire and cable applications has some drawbacks. Since flame retardant loadings are usually high, around 25% for intumescent flame retardant fillers, and 50-65% for mineral flame retardant fillers like aluminum trihydroxide (ATH) or magnesium dihydroxide (MDH), several cable related properties are negatively affected. Flame retardant cable insulation needs a combination of mechanical, flame retardant and electrical properties, which are typically challenging to meet in combination. Especially demanding applications are the American UL44 and UL4703 standards for cables, where there are demands on long term wet ageing electrical properties at 90° C. Typically, only halogen-based materials pass these requirements, as halogen free flame retardant (HFFR) materials need a loading of at least 60 wt. % of mineral filler to pass flame retardant demands, but that in turn affects the wet ageing properties negatively. The main cause for the poor electrical performance during wet ageing is a high degree of water absorption in mineral filled materials, where water increases the conductivity of the insulation, hence increasing the risk of overheating and short circuits in the cable.

Additionally in case of wire and cables, flame retardant systems cannot be too hygroscopic, as electrical, mechanical and flame retardant properties can change when the materials are exposed to moisture.

In addition, wire and cables must fulfil small scale flame retardant properties, such as flame spread, heat release and char formation, as well as wet ageing and electrical properties.

Therefore a continued interest exists in identifying halogen-free polymer compositions that meet the flame retardant standards, while they still provide superior mechanical, electrical and wet ageing properties. At the same time the polymer compositions should be more efficiently and less expensively fabricated.

The present invention is based on the finding that the addition of a comparatively low amount of a zirconium phosphate (ZrP), while concurrently reducing the content of a conventional flame retardant filler, small scale flame retardant properties, such as flame spread, heat release and char formation, are strongly improved and wet ageing at 90° C. and electrical properties remain at a high level, which has previously been a problem with phosphorus-based flame retardant additives. Moreover, it was found that the addition of ZrP improves elongation at break and tensile properties of a flame retardant polymer composition, compared to commercial highly flame retardant compounds.

Thus, the present invention is directed to a flame retardant polymer composition comprising at least the following components:
(A) 2.0 to 49.8 wt.-%, based on the overall weight of the polymer composition of an ethylene copolymer containing monomer units with polar groups;
(C) 30 to 65 wt.-%, based on the overall weight of the polymer composition of a flame retardant filler; and
(D) 2.0 to 10.0 wt.-%, based on the overall weight of the polymer composition of zirconium phosphate.

According to preferred embodiments of the invention the flame retardant polymer composition comprising the above components (A), (C), (D) may further comprise:

(B) up to 6.0 wt.-%, based on the overall weight of the polymer composition of an ethylene homo-or copolymer and/or propylene homo-or copolymer containing units originating from maleic acid anhydride.

According to other preferred embodiments of the invention the flame retardant polymer composition comprising the above components (A), (C), (D) and optionally (B) may further comprise:
(E) up to 17.0 wt.-% based on the overall weight of the polymer composition of a copolymer of ethylene and a C4 to C10 alpha olefin comonomer having a density in the range of 860 kg/m³ to 965 kg/m³, determined according to ISO 1183.

According to other preferred embodiments of the invention the flame retardant polymer composition comprising the above components (A), (C), (D) and optionally (B) and/or (E) may further comprise:
(F) up to 5 wt.-%, based on the overall weight of the polymer composition, of at least one additive described below.

Components (A) to (F) add up to 100 wt.-% of the total weight of the above polymer composition.

The present invention is further directed to a method of improving the flame retardancy of a wire or cable, wherein the above flame retardant polymer composition is used in at least one layer of the wire or cable. Moreover, the present invention provides a wire or cable comprising at least one layer comprising the above flame retardant polymer composition.

Further applications for the flame retardant polymer composition of the invention are automotive applications, health care applications and appliances.

The present invention is further directed to a wire or cable comprising at least one layer comprising the polymer composition according to the present invention.

The present invention is still further directed to the use of zirconium phosphate for improving the flame retardant properties of a hydrated filler, preferably for improving the flame retardant properties of the above flame retardant polymer composition.

The polymer compositions in accordance with the present invention comprise the components (A), (C) and (D) and optionally components (B) and/or (E) and/or optional additives (F). The components (A), (C) and (D) and optionally components (B) and/or (E) and/or optional additives add up to 100 wt.-% in sum. Within these limits, the above and below ranges for each of the individual components may be combined in any combination with the above and below ranges of each of the other components.

### Component (A)

The polymer composition in accordance with the present invention comprises as component (A) 2.0 to 49.8 wt.-% based on the overall weight of the polymer composition of a copolymer comprising ethylene units and monomer units with polar groups.

Preferably, the monomer units with polar groups are selected from the group consisting of acrylic acids, methacrylic acids, acrylates, methacrylates, acetates and vinyl acetates and mixtures thereof.

More preferably, the polar groups are selected from the group consisting of (a) vinyl carboxylate esters, preferably vinyl acetate and mixtures thereof, (b) (meth) acrylates, preferably methyl acrylate, and mixtures thereof; (c) olefinically unsaturated carboxylic acids, and mixtures thereof; (d) (meth) acrylic acid derivatives, and mixtures thereof; (e) vinyl ethers, and mixtures thereof, and (f) units comprising hydrolysable silane groups, preferably vinylsilane groups, and mixtures thereof. The polar groups may further preferably be selected from the group consisting of alkyl acrylates, alkyl methacrylates, and vinyl acetates. Even more preferably, the polar groups are selected from the group consisting of C₁-to C₆-alkyl acrylates, C₁-to C₆-alkyl methacrylates, and vinyl acetates. Still more preferably, the polar groups are selected from the group consisting of C₁-to C₄-alkyl, such as methyl, ethyl, propyl or butyl acrylates or vinyl acetate. Component (A) may also comprise a combination of the above polar group-containing units.

For example, polar monomer units may be selected from the group of alkyl esters of (meth) acrylic acid, such as methyl, ethyl and butyl (meth) acrylate and vinyl acetate. In a particularly preferred embodiment (A) is an ethylene vinyl acetate copolymer, an ethylene methyl acrylate or ethylene butyl acrylate copolymer, or combinations thereof.

Preferably, the content of component (A) in the polymer composition is in the range of 7.5 to 40.5 wt.-%, more preferably in the range of 15.5 to 32 wt.-% and even more preferably in the range of 19.8 to 26.7 wt.-%, based on the overall weight of the polymer composition.

Preferably, the ethylene copolymer (A) comprising polar groups is prepared by copolymerising ethylene and at least a polar comonomer mentioned above. However, it may also be produced by grafting the polar group onto the homo-or copolymer backbone. The ethylene copolymer (A) may also be a terpolymer, preferably an ethylene (meth) acrylate terpolymer, or an ethylene vinyl acetate terpolymer. These terpolymers may further comprise silane-containing units described below.

When the polar copolymer is prepared by copolymerising ethylene with a polar comonomer, this is preferably effected in a high pressure process resulting in low density ethylene copolymer or in a low pressure process in the presence of any suitable catalyst, for example a chromium, Ziegler-Natta or single-site catalyst.

Preferably, component (A) has a polar comonomer content from 10 to 35 mol %, more preferably from 15 to 30 mol % or even more preferably from 20 to 30 mol %.

Preferably component (A) is a copolymer of ethylene and vinyl acetate having a polar comonomer content in the range of 20 to 30 wt.-% and preferably 23 to 27 wt.-% based on the total weight of the copolymer.

Preferably component (A) has a melt flow rate MFR (190° C., 2.16 kg) of 0.1 to 50 g/10 min, more preferably of 0.1 to 10 g/10 min and even more preferably of 0.2 to 3.0 g/10 min.

Preferably, component (A) has a density determined according to ISO 1183 in the range of 920 to 960 kg/m³ and more preferably in the range of 935 to 950 kg/m³.

Component (A) may further comprise units with hydrolysable silane groups, wherein the units with hydrolysable silane-groups are preferably represented by formula (I):

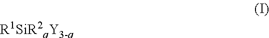

wherein R¹ preferably is an ethylenically unsaturated hydrocarbyl, hydrocarbyloxy or (meth) acryloxy hydrocarbyl group, each R² preferably is independently an aliphatic saturated hydrocarbyl group, Y which may be the same or different, is preferably a hydrolysable organic group and q is 0, 1 or 2. The content of the comonomer units comprising a crosslinkable silane group is preferably 0.2 to 4 wt.-%, based on the overall weight of component (A). Such hydrolysable silane group(s) containing comonomer or compound can be crosslinked, if desired.

If component (A) comprises units with hydrolysable silane groups, it may preferably be an ethylene vinylsilane copolymer, preferably comprising one or more of the above polar comonomer units, such as e.g. vinyl acetate and/or methyl acrylate. Component (A) may further preferably encompass a terpolymer of ethylene vinylsilane with EVA and EMA.

The silane group(s) containing units can be present in the polymer of component (A) as a comonomer or as a compound grafted chemically to the polymer. In general, copolymerisation of the silane group(s) containing comonomer to ethylene monomer and grafting of the silane group(s) containing units are well-known techniques and well documented in the polymer field and within the skills of a skilled person.

Grafting is incorporating, after polymerisation of an ethylene polymer, a compound of silane group(s) containing units chemically (using e.g. peroxide) into the backbone of the produced ethylene polymer.

Preferably the silane group(s) containing units are present as a comonomer in the polymer of component (A). In this embodiment the polymer is preferably produced by copolymerising ethylene monomer in the presence of a polar comonomer and a silane group(s) containing comonomer. The copolymerisation is preferably carried out in a high pressure reactor using a radical initiator.

Suitable components which may be used as component (A) according to the present invention are commercially available, for example from DuPont (USA) under the trade name Elvaloy® or under the trade name Escorene® from Exxon Mobil (USA).

### Component (B)

The polymer composition in accordance with the present invention may comprise as component (B) 0 to 6.0 wt.-%, based on the overall weight of the polymer composition of an ethylene homo-or copolymer and/or propylene homo-or copolymer containing units originating from maleic acid anhydride. Thus, component (B) may be present in or absent from the flame retardant composition of the present invention.

Preferably, component (B) is contained in the polymer composition of the invention in the range of 1.0 to 6.0 wt.-%, preferably in the range of 2.5 to 5.5 wt.-%, more preferably 4.0 to 5.2 wt.-%, still more preferably 4.5 to 5.2 wt.-% and even more preferably in the range of 4.8 to 5.2 wt.-%, based on the overall weight of the polymer composition.

In accordance with the present invention component (B) may preferably be obtained by copolymerising and/or grafting an ethylene homo-or copolymer with maleic acid anhydride, whereby a grafted linear low density polyethylene is preferred.

The content of maleic acid anhydride is preferably in the range of 0.15 to 2.0 wt.-%, more preferably in the range of from 0.2 to 1.0 wt.-%.

Preferably, component (B) has a density determined according to ISO 1183 in the range of 910 to 950 kg/m³ and preferably in the range of 920 to 940 kg/m³.

It is further preferred that component (B) has a MFR₂ determined according to ISO 1133 in the range of 0.5 to 5 g/10 min and more preferably in the range of 1.5 to 2.5 g/10 min.

Suitable ethylene homo-or co polymers and/or propylene homo-or copolymers containing units originating from maleic acid anhydride which may be used as component (B) according to the present invention are commercially available, for example from HDC Hyundai EP Co., Ltd. under the tradename Polyglue® GE300C or from Auserpolimeri, Italy under the tradename Compoline CO/LL.

### Component (C)

According to the present invention, the flame retardant polymer composition comprises from 30 to 65 wt.-%, preferably 30 wt.-% to 60 wt.-%, more preferably 40 to 60 wt.-%, even more preferably not less than 50 wt.-%, based on the overall weight of the polymer composition of a flame retardant filler, or a mixture of such fillers. Each of the above weight range limits can be combined with each other.

In the present invention the flame retardant filler preferably is a hydrated filler, more preferably selected from the group consisting of aluminum hydroxide and magnesium hydroxide, and mixtures thereof.

Still more preferably, component (C) may be coated or uncoated aluminum trihydroxide, a ground or precipitated magnesium hydroxide and mixtures thereof.

Component (C) may preferably be a ground or precipitated magnesium hydroxide having a BET surface area in the range of 1 to 20 m²/g and more preferably in the range of 5 to 12 m²/g.

In accordance with the present invention a “ground magnesium hydroxide” is a magnesium hydroxide obtained by grinding minerals based on magnesium hydroxide, such as brucite and the like. Brucite is found in its pure form or, more often, in combination with other minerals such as calcite, aragonite, talc or magnesite, often in stratified form between silicate deposits, for instance in serpentine asbestos, in chlorite or in schists.

Suitable ground magnesium hydroxides which may be used as component (C) are commercially available, for example from Europiren B.V (Netherlands) under the tradename Ecopiren® 3.5C.

A preferred filler aluminum hydroxide filler is uncoated aluminum trihydroxide, commercially available under the tradename Apyral 40CD from Nabaltec AG, Germany. The aluminum hydroxide filler may preferably have a median particle size d₅₀ in the range of from 1 to 5 μm and/or a BET surface area of from 2 to 8 m²/g.

Component (C) may preferably be used in the form of particles whose surface has been treated with stearates, such as magnesium or zinc stearate; silanes or polymeric components. Component (C) may also be used without surface treatment.

### Component (D)

The flame retardant polymer composition of the present invention comprises 2.0 to 10.0 wt.-%, preferably 2.5 to 8.0 wt.-%, more preferably 3.0 to 5.0 wt.-%, based on the overall weight of the polymer composition of zirconium phosphate as a flame retardant additive. It is the finding of the present invention that the use of zirconium phosphate surprisingly improves the flame retardancy of the composition over that of using the flame retardant filler (C) alone.

It was further surprisingly found that small scale flame retardant properties, such as flame spread, heat release and char formation, are strongly improved when adding the above component (D) in the indicated amount, while concurrently reducing the residual flame retardant filler content. Also wet ageing at 90° C. and electrical properties are good, which has previously been a problem with other phosphorus-based flame retardant additives.

The zirconium phosphate may preferably be zirconium (IV) hydrogenphosphate, Zr(HPO₄)₂·H₂O, CAS No.: 13772-29-7. It is supplied as a white powder.

It has a relative density of 3.3 g/mL at 25° C. Zirconium (IV) hydrogenphosphate may be used in crystalline form as α, γ and θ form with a layered structure and τ with a 3D structure. The structure of the crystalline form is easier to control and has exfoliation and intercalation properties. Among the crystalline structures, α-zirconium (IV) hydrogen-phosphate is particularly preferred in which zirconium (IV) atoms are connected to oxygen atoms of the phosphate groups, leading to a crosslinked network. In the same layer, atoms are connected by covalent bonds, whereas the two adjacent layers are attracted by Van der Waals forces. The P—OH groups are responsible for the medium-strong Brønsted acidity of α-zirconium (IV) hydrogenphosphate, which allows the intercalation chemistry. It can be a flame retardant synergist due to the flexibility of the structure and its high thermal stability up to 800° C.

### Component (E)

The flame retardant polymer composition in accordance with the present invention may comprise 0 to 17.0 wt.-% based on the overall weight of the polymer composition of a copolymer of ethylene and a C₄ to C₁₀ alpha olefin comonomer having a density in the range of 860 kg/m³ to 965 kg/m³, determined according to ISO 1183. Thus, component (E) may be present in or absent from the flame retardant composition of the present invention.

Preferably, the content of component (E) in the polymer composition is in the range of 3.0 to 16.0 wt.-%, more preferably in the range of 5.0 to 12.0 wt.-% and even more preferably in the range of 6.0 to 11.0 wt.-%, based on the overall weight of the polymer composition.

Component (E) may preferably be a copolymer of ethylene and 1-octene; whereby said copolymer preferably has a density in the range of 860 kg/m³ to 920 kg/m³, more preferably in the range of 870 to 910 kg/m³ and even more preferably in the range of 880 to 905 kg/m³ measured according to ISO 1183.

Component (E) may comprise comonomer units with hydrolysable silane groups, as described above for component (A). The content of the comonomer units comprising hydrolysable silane groups is preferably 0.2 to 4 wt.-%, based on the overall weight of component (E).

Component (E) may preferably be produced by using a single-site catalyst and is more preferably a copolymer of ethylene and 1-octene produced by using a single-site catalyst.

Component (E) may further preferably comprise units with hydrolysable silane-groups. The same units and compounds as described for component (A) above may be used.

The MFR₂ of component (E) may preferably be in the range of 0.1 to 10.0 g/10 min, more preferably in the range of 0.5 to 5 g/10 min, even more preferably in the range of 0.5 to 3 g/10 min and still more preferably in the range of 1.0 to 3.0 g/10 min, measured according to ISO 1133 at 190° C. and a load of 2.16 kg.

A copolymer consisting of units of ethylene and 1-hexene may preferably further be used as component (E). Component (E) may be also a mixture of copolymers of ethylene and 1-octene and ethylene and 1-hexene.

A preferred copolymer consisting of units of ethylene and 1-hexene has a content of 1-hexene in the range of 0.02 to 15 wt.-% and more preferably in the range of 0.5 to 5.0 wt.-% based on the overall weight of component (E). Preferably the density of said copolymer of ethylene and 1-hexene is in the range of 920 kg/m³ to 965 kg/m³, more preferably in the range of 930 to 960 kg/m³ and still more preferably in the range of 945 to 955 kg/m³ measured according to ISO 1183.

The MFR₂ of said copolymer of ethylene and 1-hexene may preferably be in the range of 2.0 to 40.0 g/10 min, more preferably in the range of 3.0 to 30.0 g/10 min, even more preferably in the range of 4.0 to 20.0 g/10 min and still more preferably in the range of 5.0 to 15.0 g/10 min, measured according to ISO 1133 at 190° C. and a load of 21.6 kg.

Copolymers of ethylene and 1-octene which may suitably be used as component (E) are commercially available, for example from Borealis AG (Austria) under the trade names Queo® 0201, Queo® 8201 or Queo® 8203.

Copolymers of ethylene and 1-hexene which may also suitably be used as component (E) are commercially available, for example from Borealis AG (Austria) under the trade names Borsafe® HE3490-LS-H or Borsafe® HE3493-LS-H.

### Additives

The polymer composition according to the present invention may also comprise additives. Preferably, the flame retardant polymer composition of the invention comprises at least one additive preferably selected from the group consisting of slip agents, UV-stabiliser, antioxidants, additive carriers, nucleating agents, mica and mixtures thereof, whereby these additives preferably are present in an amount of from 0.01 to 5 wt.-%, more preferably in an amount of from 0.1 to 4 wt.-%, based on the overall weight of the polymer composition. The flame retardant polymer composition of the invention may further preferably comprise mica, more preferably in an amount of from 2.5 to 3.5 wt.-%, based on the overall weight of the polymer composition.

The flame retardant polymer composition of the invention may preferably comprise an antioxidant comprising a sterically hindered phenol group or aliphatic sulphur groups. Such compounds are disclosed in EP 1 254 923 A1 as particularly suitable antioxidants for stabilisation of polyolefin containing hydrolysable silane groups. Other preferred antioxidants are disclosed in WO 2005/003199 A1. Preferably, the antioxidant is present in the composition in an amount of from 0.01 to 3 wt.-%, more preferably 0.05 to 2 wt.-%, and most preferably 0.08 to 1.5 wt.-%, based on the overall weight of the polymer composition.

When the flame retardant polymer composition of the present invention is crosslinked, it may comprise a scorch retarder. The scorch retarder may be a silane-containing scorch retarder as described in EP 0 449 939 A1. If applicable, the scorch retarder may be present in the composition in an amount from 0.3 wt.-% to 5.0 wt.-%, based on the overall weight of the composition.

### Polymer Composition

The polymer composition of the present invention comprises at least components (A), (C) and (D) and optionally further comprises at least one of components (B), (E) and (F). The preferred embodiments of the invention are set out in the example section.

Components (A) to (F) may be incorporated into the polymer composition in the amounts and including the parameters and properties as discussed in detail above. All ranges of one individual component may be combined with each range of any of the other components in any level of preference.

The polymer compositions of the invention exhibit a superior combination of improved flame retardancy, especially heat release rate and UL94 rating, mechanical properties, such as tensile strength and elongation at break, and low water absorption.

Specifically preferred embodiments of the polymer composition of the present invention may encompass 15.5 to 32 wt.-%, more preferably 19.8 to 26.7 wt.-% of component (A), 2.5 to 5.5 wt.-%, more preferably 4.0 to 5.2 wt.-%, still more preferably 4.5 to 5.2 wt.-% and even more preferably 4.8 to 5.2 wt.-% of component (B), 40 to 60 wt.-%, more preferably not less than 50 wt.-% of component (C), 2.5 to 8 wt.-%, more preferably 3.0 to 5.0 wt.-% of component (D), and 5.0 to 12.0 wt.-%, more preferably 6.0 to 11.0 wt.-% of component (E).

Within any one of these embodiments, a polymer composition of the present invention may encompass component (A) having a MFR₂ in the range of from 0.2 to 3.0 g/10 min, including 2.0 g/10 min, a density in the range of from 935 to 950 kg/m³, including 948 kg/m³, and within the above ranges, may optionally include polar comonomer units. Such a preferred component (A) may further preferably encompass a terpolymer of ethylene vinylsilane with EVA and EMA and even more preferably may be a copolymer of ethylene and vinyl acetate (EVA).

Within any one of these embodiments, a polymer composition of the present invention may encompass component (B) having a MFR₂ in the range of from 1.5 to 2.5 g/10 min, including 1.8 g/10 min, a density in the range of from 920 to 940 kg/m³, including 930 kg/m³, and within the above ranges, may further preferably encompass a linear low density polyethylene grafted with maleic acid anhydride (maleic acid anhydride content=0.15 to 2.0 wt.-%, more preferably 0.5 to 1.0 wt.-%).

Within any one of these embodiments, a polymer composition of the present invention may encompass component (C) being an uncoated aluminum trihydroxide having a median particle size d₅₀ in the range of from 1 to 5 μm, including 1.5 μm and/or a BET surface area of from 2 to 8 m²/g, including 3.5 m²/g.

Within any one of these embodiments, a polymer composition of the present invention may encompass component (D) being a zirconium (IV) hydrogenphosphate, Zr(HPO₄)₂·H₂O, more preferably in the a-form, having a relative density of 3.3 g/mL at 25 C.

Within any one of these embodiments, a polymer composition of the present invention may encompass component (E) having a MFR₂ in the range of 0.5 to 3 g/10 min, including 1.0 g/10 min, measured according to ISO 1133 at 190° C. and a load of 2.16 kg, a density in the range of from 870 to 910 kg/m³, more preferably in the range of from 880 to 905 kg/m³, including 902 kg/m³, measured according to ISO 1183, and within the above ranges, may further preferably encompass a very low density copolymer of ethylene and 1-octene.

Within any one of these embodiments, a polymer composition of the present invention may encompass component (F) in a range of from 0.01 to 5 wt.-%, more preferably from 0.1 to 4 wt.-% and may include an antioxidant in a range of from 0.05 to 2 wt.-%, more preferably from 0.08 to 1.5 wt.-%, including 0.2 wt.-%.

Any one of the above described embodiments may be combined with each other in any combination of the indicated numerical ranges, independent from the level of preference. Any one of the above preferred embodiments show the above-discussed preferred combination of properties, such as improved flame retardant properties, including limiting oxygen index (LOI), UL94 rating, peak heat release rate (pHRR), reduced water absorption, while mechanical properties are maintained at a high level.

Particularly, any of the above preferred embodiments of the polymer composition of the present invention may exhibit a tensile strength, determined as described in the experimental section, of at least 10 MPa, more preferably in the range of from 10 to 30 MPa., and/or an elongation at break, determined as described in the experimental section, of at least 150%, more preferably in the range of from 150 to 400%, and/or a water absorption, determined as described in the experimental section, of not more than 4.00 mg/cm² (14 d, 90° C.), more preferably in the range of from 0.50 to 3.50 mg/cm² (14 d, 90° C.), and/or a limiting oxygen index (LOI), determined as described in the experimental section, of at least 34.8%, more preferably in the range of from 35 to 50%, and/or an UL94 rating, determined as described in the experimental section, of at least V-1, more preferably V-2, and/or a peak heat release rate (pHHR), determined as described in the experimental section, of not more than 155 kW/m², more preferably in the range of from 50 to 150 kW/m².

A preferred flame retardant polymer composition in accordance with the present invention comprises the following components and preferably consists of these components:
(A) 2.0 to 49.8 wt.-%, preferably 20 to 30 wt.-% based on the overall weight of the polymer composition of an ethylene copolymer containing monomer units with polar groups, preferably of an ethylene vinyl acetate;
(B) up to 6.0 wt.-%, preferably 4.5 to 5.5 wt.-% based on the overall weight of the polymer composition of a polyethylene homo-or copolymer and/or propylene homo-or copolymer containing units originating from maleic acid anhydride, prefer an MAH-grafted LLDPE;
(C) 30 to 65 wt.-%, preferably 48 to 52 wt.-% based on the overall weight of the polymer composition of a flame retardant filler, preferably aluminum trihydroxide;
(D) 2.0 to 10.0 wt.-%, preferably 2.5 to 5.5 wt.-% based on the overall weight of the polymer composition of zirconium phosphate;
(E) up to 17.0 wt.-%, preferably 9 to 11 wt.-% based on the overall weight of the polymer composition of a copolymer of ethylene and a C₄ to C₁₀ alpha olefin comonomer having a density in the range of 860 kg/m³ to 965 kg/m³ determined according to ISO 1183, preferably a copolymer of ethylene and 1-octene.

### Wire or Cable

The present invention further relates to a wire or cable comprising at least one layer comprising the flame retardant polymer composition in accordance with the present invention.

Preferably, the at least one layer comprising the flame retardant polymer composition of the present invention may be cross-linked.

The wire or cable may be produced by co-extrusion of the different layers onto a conducting core. Then, crosslinking is optionally performed, preferably by moisture curing in case that component (A) comprises comonomer units comprising a crosslinkable silane group, wherein the silane groups are hydrolyzed under the influence of water or steam. Moisture curing is preferably performed in a sauna or water bath at temperatures of 70 to 100° C. or at ambient conditions.

The polymer composition in accordance with the present invention can be extruded around a wire or cable to form an insulating or jacketing layer or can be used as bedding compounds. Preferably, it is comprised in an insulation layer of a power cable.

The polymer compositions are then optionally crosslinked.

It is preferred that the wire or cable comprises an insulation layer, preferably comprising or consisting of a material selected from the group consisting of crosslinked or thermoplastic polyethylene, thermoplastic polypropylene or flame retardant polyolefins. Suitable flame retardant polyolefins are inter alia described in WO 2013/159942 A2. Suited thermoplastic insulations are for example disclosed in WO 2007/137711 A1 or WO 2013/1599442 A2 and are commercially available for example from Borealis AG (Austria) under the tradenames FR4802, FR4803, FR4807, FR6082, FR6083 and FR4804. Commercially available crosslinkable insulation materials are also available from Borealis AG (Austria) under the tradenames FR4850 and FR4851.

An insulation layer of a low voltage power cable may have a thickness in the range of 0.4 mm to 3.0 mm, preferably below 2.0 mm, depending on the application. Preferably, the insulation is directly coated onto the electric conductor.

### Use

The present invention further relates to the use of the flame retardant polymer composition of the present invention as a flame retardant layer of a wire or cable.

The use of the polyolefin composition of the present invention as a flame retardant layer may comprise cross-linking thereof.

The present invention further relates to the use of zirconium phosphate for improving the flame retardant and/or water absorption properties of a hydrated filler as described above or of a polymer composition which comprises a hydrated filler, preferably a polymer composition which comprises at least components (A) and (C) defined above, wherein zirconium phosphate is added to the polymer composition in an amount of 2.0 to 10.0 wt.-%, based on the overall weight of the polymer composition.

The present invention further relates to a method of improving the flame retardant and/or water absorption properties of a wire or cable, wherein the polymer composition as defined above is used in at least one layer of the wire or cable.

The flame retardant polymer composition of the present invention is particularly useful for automotive applications, health care applications and appliances.

All preferred aspects and embodiments as described above shall also hold for the use according to the present invention.

The invention will now be described with reference to the following non-limiting examples.

### Experimental Part

A. Measuring methods

The following definitions of terms and determination methods apply for the above general description of the invention as well as to the below examples unless otherwise defined.

### 1. Melt Flow Rate (MFR)

The MFR was measured according to ISO 1133 (Davenport R-1293 from Daventest Ltd). MFR values were measured at two different loads 2.16 kg (MFR₂) and 21.6 kg (MFR₂₁) at 190° C.

### 2. Density

The density was measured according to ISO 1183-1-method A (2019). Sample preparation was done by compression moulding in accordance with ISO 1872-2:2007.

3. Comonomer content in component A)

The content (wt % and mol %) of polar comonomer present in the polymer and the content (wt % and mol %) of silane group(s) containing units present in the polymer composition was determined by quantitative nuclear-magnetic resonance (NMR) spectroscopy.

Quantitative ¹H NMR spectra recorded in the solution-state using a Bruker Advance III 400 NMR spectrometer operating at 400.15 MHz. All spectra were recorded using a standard broad-band inverse 5 mm probehead at 100° C. using nitrogen gas for all pneumatics. Approximately 200 mg of material was dissolved in 1,2-tetrachloroethane-d₂ (TCE-d₂) using ditertiarybutylhydroxytoluen (BHT) (CAS 128-37-0) as stabiliser. Standard single-pulse excitation was employed utilising a 30 degree pulse, a relaxation delay of 3 s and no sample rotation. A total of 16 transients were acquired per spectra using 2 dummy scans. A total of 32k data points were collected per FID with a dwell time of 60 μs, which corresponded to to a spectral window of approx. 20 ppm. The FID was then zero filled to 64k data points and an exponential window function applied with 0.3 Hz line-broadening. This setup was chosen primarily for the ability to resolve the quantitative signals resulting from methylacrylate and vinyltrimethylsiloxane copolymerisation when present in the same polymer.

Quantitative ¹H NMR spectra were processed, integrated and quantitative properties determined using custom spectral analysis automation programs. All chemical shifts were internally referenced to the residual protonated solvent signal at 5.95 ppm.

When present, characteristic signals resulting from the incorporation of vinyl acetate (VA), methyl acrylate (MA), butyl acrylate (BA) and vinyltrimethylsiloxane (VTMS), in various comonomer sequences, were observed (Randell89). All comonomer contents calculated with respect to all other monomers present in the polymer.

The vinyl acetate (VA) incorporation was quantified using the integral of the signal at 4.84 ppm assigned to the *VA sites, accounting for the number of reporting nuclei per comonomer and correcting for the overlap of the OH protons from BHT when present:

$$V A = ( {I}_{* V A} - ( {I}_{ArBHT )} / 2 ) / 1$$

The methyl acrylate (MA) incorporation was quantified using the integral of the signal at 3.65 ppm assigned to the 1MA sites, accounting for the number of reporting nuclei per comonomer:

$$MA = {I}_{1 MA} / 3$$

The butyl acrylate (BA) incorporation was quantified using the integral of the signal at 4.08 ppm assigned to the 4BA sites, accounting for the number of reporting nuclei per comonomer:

$$BA = {I}_{4 B A} / 2$$

The vinyl trimethylsiloxane incorporation was quantified using the integral of the signal at 3.56 ppm assigned to the 1VTMS sites, accounting for the number of reporting nuclei per comonomer:

$$VTMS = {I}_{1 VTMS} / 9$$

Characteristic signals resulting from the additional use of BHT as stabiliser, were observed. The BHT content was quantified using the integral of the signal at 6.93 ppm assigned to the ArBHT sites, accounting for the number of reporting nuclei per molecule:

$$BHT = {I}_{ArBHT} / 2$$

The ethylene comonomer content was quantified using the integral of the bulk aliphatic (bulk) signal between 0.00-3.00 ppm. This integral may include the 1VA (3) and αVA (2) sites from isolated vinyl acetate incorporation, MA and aMA sites from isolated methyl acrylate incorporation, 1BA (3), 2BA (2), 3BA (2), BA (1) and aBA (2) sites from isolated butyl acrylate incorporation, the VTMS and aVTMS sites from isolated vinylsilane incorporation and the aliphatic sites from BHT as well as the sites from polyethylene sequences. The total ethylene comonomer content was calculated based on the bulk integral and compensating for the observed comonomer sequences and BHT:

$$E = ( 1 / 4 ) * [ {I}_{bulk} - 5 * VA - 3 * MA - 10 * BA - 3 * VTMS - 21 * BHT ]$$

It should be noted that half of the a signals in the bulk signal represent ethylene and not comonomer and that an insignificant error is introduced due to the inability to compensate for the two saturated chain ends(S) without associated branch sites.

The total mole fractions of a given monomer (M) in the polymer was calculated as:

$$fM = M / ( E + V A + M A + BA + VTMS )$$

The total comonomer incorporation of a given monomer (M) in mole percent was calculated from the mole fractions in the standard manner:

$$M [ mol \% ] = 100 * fM$$

The total comonomer incorporation of a given monomer (M) in weight percent was calculated from the mole fractions and molecular weight of the monomer (MW) in the standard manner:

$$M [ wt \% ] = 100 * ( fM * M W ) / ( ( fVA * 86.09 ) + ( fMA * 86.09 ) + ( fBA * 128. 17 ) + ( fVTMS * 148.23 ) + ( ( 1 - fVA - fMA - fBA - fVTMS ) * 28.05 ) )$$

randall89: J. Randall, Macromol. Sci., Rev. Macromol. Chem. Phys. 1989, C29, 201.

If characteristic signals from other specific chemical species are observed the logic of quantification and/or compensation can be extended in a similar manor to that used for the specifically described chemical species. That is, identification of characteristic signals, quantification by integration of a specific signal or signals, scaling for the number of reported nuclei and compensation in the bulk integral and related calculations. Although this process is specific to the specific chemical species in question the approach is based on the basic principles of quantitative NMR spectroscopy of polymers and thus can be implemented by a person skilled in the art as needed.

4. Median Particle Size (d50)

Median particle size of metal hydroxide can be measured by laser diffraction (ISO13320), dynamic light scattering (ISO22412) or sieve analysis (ASTMD1921-06). For the metal hydroxides used in the working examples, the determination of the median particle size d₅₀ was conducted by laser diffraction. Any limitation of the claims shall refer to values obtained from laser diffraction (ISO13320).

5. BET surface

The BET surface is determined in accordance with ISO 9277 (2010).

6. Manufacturing of tape used for determination of tensile strength and elongation at break

For determining the tensile strength and elongation at break, tapes (1.8 mm) were produced on a Collin TeachLine E20T tape extruder with a 4.2:1, 20D compression screw with a 20 mm diameter. The temperature profile was 120/140/150/160° C. and the screw speed was 55 rpm.

### 7. Tensile Testing

Tensile testing was executed in accordance with ISO 527-1 and ISO 527-2 using an Alwetron TCT 10 tensile tester. Ten test specimen were punched from a plaque using ISO 527-2/5A specimen and placed in a climate room with relative humidity of 50+5% at a temperature of 23° C. for at least 16 hours before the test. The test specimen were placed vertically between clamps with a distance of 50±2 mm, extensometer clamps with a distance of 20 mm and a load cell of 1 kN. Before the test was carried out, the exact width and thickness for every sample was measured and recorded. Each sample rod was tensile tested with a constant speed of 50 mm/min until breakage and at least 6 approved parallels were performed. In highly filled systems, there is generally a big variation of the results and therefore the median value was used to extract a single value for elongation at break (%) and tensile strength (MPa).

### 8. Compression Moulding

Plaques were prepared for the limiting oxygen index and the UL94 flammability test (Collin R 1358, edition: 2/060510) according to ISO 293. The pellets were pressed in between two Mylar film sheets and positioned in a specific frame with the correct shape and dimensions (140×150×3 mm). The samples were pressed by applying 20 bar for a minute at 170° C., followed by 200 bars pressure for 5 minutes at the same temperature. The remaining compression was done at the same high pressure for 9 minutes at a cooling rate of 15° C./min. The amount of pellets used for each plaque was calculated using the density of the material with an excess of 10 wt.-%.

### 9. Limiting Oxygen Index

Limiting oxygen index (LOI) was performed by following a test method based on ASTM D

2863-87 and ISO 4589 [38]. 10 test specimens for LOI were stamped out of previously mentioned pressed plaques. The test specimens were 12.5±0.5 mm long. Lines were drawn at 50 mm, measured from the top of the sticks. The samples sticks were placed vertically in a glass container with a predetermined atmosphere of oxygen and nitrogen. The samples were exposed to the predetermined atmosphere for at least 30 seconds before ignition. The sticks were ignited on the very top of the specimen during contact with an external flame for five seconds. If the stick was still burning after three minutes or if the flame had burned down past the measured 50 mm, the test had failed. Different ratios of oxygen and nitrogen were tested until the specimen passed the test and the current percentage of oxygen was recorded.

10. Flammability test according to UL94

The UL94 test by Underwriters Laboratories (UL) specifies a method for the classification of flammability of plastics. It is equivalent to IEC/DIN EN 60695 -11-10 and-20.

Samples of 125×13×3 mm were punched out from compression moulded plaques. Samples were conditioned min 48 h in 23C and 50% RH before testing. UL94 test was performed in a UL94 test chamber Atlas HVUL. The test sample is subjected to 10 s ignition with a vertically placed 50 W burner with the burner tip 10 mm from the bottom of the test object. Flame is around 20 mm. Time to extinguishing of the sample is t1, and after the sample has extinguished, flame is re-applied 10 s and time to extinguishing is t2.

| Criteria | V-0 | V-1 | V-2 |
|---|---|---|---|
| Burning time of each specimen after | ≤10 s | ≤30 s | ≤30 s |
| first or second flame application | | | |
| Total burning time for all 5 specimen | ≤50 s | ≤250 s | ≤250 s |
| Burning and afterglow times after the | ≤30 s | ≤60 s | ≤60 s |
| second ignition time | | | |
| Dripping of burning specimens, ignition | No | No | Yes |
| of cotton | | | |
| Afterflame or glow of any specimen up | No | No | No |
| to holding clamp | | | |

Notes are made on dripping of sample, or full combustion of the test object. Classification is V-0, V-1 or V.2

11. Cone calorimeter

The cone calorimeter (Dual cone calorimeter from Fire Testing Technology, FTT) method was carried out by following ISO 5660. The plaques prepared as described above were placed in a climate room with relative humidity 50±5% and temperature 23° C. for at least 24 hours prior to the test. Before initializing the tests, the smoke system, gas analyzers, c-factor value, heat flux and scale were calibrated through software ConeCalc 5. Drying aid and Balston filter were checked and exchanged if necessary. The sample plaques were weighed and the exact dimensions were determined before the bottom and sides were wrapped in a 0.3 mm thick aluminium foil and placed in a sample holder filled with a fiber blanket and a frame on top. The sample was placed in a horizontal position on a loading cell 60 mm from the cone radiant heater with heat f lux 35 kW/m² and volume flow rate 24 l/min. Heat release rate, time to ignition and smoke production among others was tested in a FTT cone calorimeter according to ISO5660-1:2019. Test objects were compression moulded plaques of 100×100×3 mm. The maximum heat release is recorded as peak heat release rate (pHRR).

12. Water absorption

Water absorption was measured according to IEC 60811-402:2012. Test objects were approx. 80×6×0.8 mm and were predried under vacuum at 70 C 24 h. Thereafter the samples were weighed followed by subsequent submersion in 90 C deionized water for 14 days. Sample were cooled in the water, then retracted from the water, surface water wiped off and then weighed again. Finally samples were dried again under vacuum at 70° C. until constant weight. The water absorption was described as mg/cm², where cm² is the surface area of the test object.

### B. Materials

### Component A

“EVA” is a copolymer of ethylene and vinyl acetate (weight ratio=75:25) having a MFR₂ of 2.0 g/10 min and a density of 948 kg/m³, commercially available from Borealis under the name of OE53251.

### Component B

“LLDPE-MAH” is a linear low density polyethylene grafted with maleic acid anhydride (maleic acid anhydride content=0.5 to 1.0 wt.-%, MFR₂=1.8 g/10 min, density=930 kg/m³), commercially available from Auserpolimeri under the name of Compoline CO/LL.

### Component C

“ATH” is an uncoated aluminum trihydroxide (ATH) with d₅₀=1.5 μm, BET=3.5 m²/g. The chemical composition is 99.5% ATH, 0.011% NA2= and 0.2% moisture.

### Component D

“ZrP” is a-zirconium (IV) hydrogenphosphate, commercially available from Sunshine Factory Co., Ltd., China.

### Component E

“VLDPE” is is a very low density copolymer of ethylene and 1-octene having a density of 902 kg/m³ and a MFR₂ of 1.0 g/10 min, commercially available as Queo 0201 from Borealis AG (Austria).

### Additive

“Irg1010” is an antioxidant which is pentaerythritol tetrakis [3-[3,5-di-tert-butyl-4-hydroxyphenyl] propionate, commercially available from BASF, Germany.

Table 1 shows the ingredients and properties of the polymer compositions according to the comparative examples and the inventive example.

TABLE 1

| | IE1 | IE2 | CE1 | CE2 |
|---|---|---|---|---|
| EVA (A) | 24.8 | 24.8 | 24.8 | 24.8 |
| VLDPE (E) | 10.0 | 10.0 | 10.0 | 10.0 |
| LLDPE-MAH (B) | 5.0 | 5.0 | 5.0 | 5.0 |
| Irg 1010 | 0.2 | 0.2 | 0.2 | 0.2 |
| ATH (C) | 55.0 | 57.0 | 60.0 | 59.0 |
| ZrP (D) | 5.0 | 3.0 | — | 1.0 |
| Tensile strength, MPa | 14.2 | 14.3 | 14.6 | 14.5 |
| Elongation at break, % | 250.0 | 291.0 | 318.0 | 300.3 |
| Water absorption, 14 d | 2.84 | 2.92 | 4.06 | 2.93 |
| 90° C., mg/cm² | | | | |
| LOI, % | 37.0 | 36.0 | 34.0 | 34.5 |
| UL94 rating* | V-0 | >V-2 (2/5 is V-0) | >V-2 | >V-2 |
| Cone- pHRR (kW/m²) | 91.9 | 145.8 | 159.0 | 164.5 |

*>V-2, sample do not meet V-2 classification

The above results show that the composition according to IE1 achieves improved flame retardant properties, such as LOI, UL94 rating and pHRR, reduced water absorption, while mechanical properties are maintained at a high level, compared to CE1 which does not contain zirconium phosphate.

IE2, comprising a reduced concentration of zirconium phosphate still is improved in water absorption, LOI and pHRR, while mechanical properties are comparable.

It should be further noted that the above superior properties of the inventive examples could be obtained at reduced levels of the flame retardant filler.

Thus, it is evident that the addition of a relatively small amount of zirconium phosphate as a flame retardant synergist significantly improves the small scale flame retardant properties and water absorption of a polymer composition, while mechanical properties are maintained at a high level.

1. A flame retardant polymer composition comprising at least the following components:
(A) 2.0 to 49.8 wt.-%, based on the overall weight of the polymer composition of an ethylene copolymer containing monomer units with polar groups;
(C) 30 to 65 wt.-%, based on the overall weight of the polymer composition of a flame retardant filler;
(D) 2.0 to 10.0 wt.-%, based on the overall weight of the polymer composition of zirconium phosphate.

2. The flame retardant polymer composition according to claim 1, wherein the monomer units with polar groups of component (A) are selected from the group consisting of (a) vinyl carboxylate esters and mixtures thereof; (b) (meth) acrylates and mixtures thereof; (c) olefinically unsaturated carboxylic acids, and mixtures thereof; (d) (meth) acrylic acid derivatives, and mixtures thereof; (e) vinyl ethers, and mixtures thereof, and (f) units comprising hydrolysable silane groups, and mixtures thereof.

3. The flame retardant polymer composition according to claim 1, wherein component (A) has a polar comonomer content from 10 to 35 mol %, and/or
component (A) has a melt flow rate MFR (190° C., 2.16 kg) of 0.1 to 50 g/10 min.

4. The flame retardant polymer composition according to claim 1, wherein the flame retardant filler of component (C) is a hydrated filler, selected from the group consisting of aluminum hydroxide and magnesium hydroxide and mixtures thereof.

5. The flame retardant polymer composition according to claim 1, further comprising:
(B) up to 6.0 wt.-%, based on the overall weight of the polymer composition of an ethylene homo-or copolymer and/or a propylene homo-or copolymer containing units originating from maleic acid anhydride; and/or
(E) up to 17.0 wt.-% based on the overall weight of the polymer composition of a copolymer of ethylene and a C₄ to C₁₀ alpha olefin comonomer having a density in the range of 860 kg/m³ to 965 kg/m³ determined according to ISO 1183.

6. The flame retardant polymer composition according to claim 5, wherein component (E) comprises a copolymer of ethylene and 1-octene; whereby said copolymer has
a density in the range of 870 kg/m³ to 910 kg/m³, measured according to ISO 1183; and/or
an MFR₂ in the range of 0.1 to 10.0 g/10 min, measured according to ISO 1133 at 190° C. and a load of 2.16 kg.

7. The flame retardant polymer composition according to claim 5, wherein component (B) is obtained by copolymerising and/or grafting polyethylene with maleic acid anhydride, whereby the content of maleic acid anhydride is in the range of 0.15 to 2.0 wt.-%; and/or
component (B) has a density determined according to ISO 1183 in the range of 910 to 950 kg/m³, and/or
component (B) has a MFR₂ determined according to ISO 1133 in the range of 0.5 to 5 g/10 min; and/or
wherein component (B) is a linear low-density polyethylene grafted with maleic acid anhydride.

8. The flame retardant polymer composition according to claim 1, wherein component (A) and/or component (E) comprise(s) comonomer units comprising hydrolysable silane-groups.

9. The flame retardant polymer composition according to claim 1, wherein the polymer composition has a tensile strength, determined as described in the experimental section, in the range of from 10 to 30 MPa, and/or
an elongation at break, determined as described in the experimental section, in the range of from 150 to 400%, and/or
a water absorption, determined as described in the experimental section, in the range of from 0.50 to 4.00 mg/cm², 14 d, 90° C.

10. The flame retardant polymer composition according to claim 1, wherein the polymer composition has a limiting oxygen index (LOI), determined as described in the experimental section, in the range of from 34.8 to 50%, and/or
an UL94 rating, determined as described in the experimental section, of at least V-1, and/or
a peak heat release rate (pHHR), determined as described in the experimental section, in the range of from 50 to 155 kW/m².

11. A method of improving the flame retardant and/or water absorption properties of a wire or cable, wherein the polymer composition according to claim 1 is used in at least one layer of the wire or cable.

12. A wire or cable comprising at least one layer comprising the polymer composition according to claim 1.

13. A method, comprising using the wire or cable according to claim 12 in an automotive applications, a health care application, or an appliances.

14. (canceled)

15. A method for improving the flame retardant and/or water absorption properties of a polymer composition comprising a hydrated filler, comprising adding zirconium phosphate to the polymer composition in an amount of 2.0 to 10.0 wt.-%, based on the overall weight of the polymer composition.

16. The flame retardant polymer composition according to claim 2, wherein the vinyl carboxylate ester is vinyl acetate.

17. The flame retardant polymer composition according to claim 2, wherein the (meth) acrylate is methyl acrylate.

18. The flame retardant polymer composition according to claim 2, wherein the hydrolysable silane group is a vinylsilane group.

19. The flame retardant polymer composition according to claim 4, wherein the hydrated filler is aluminum trihydroxide, ground or precipitated magnesium hydroxide, or mixtures thereof.
